(19) United States
(12) Patent Application Publication
(10) Pub. No.: US 2015/0334428 A1
(43) Pub. Date: Nov. 19, 2015

(54) Data Distribution Apparatus

(71) Applicant: GLOBAL INVACOM LTD., Hertfordshire (GB)

(72) Inventor: Gary Stafford, Hertfordshire (GB)

(73) Assignee: Global InvaCom Ltd, Hertforshire (GB)

(21) Appl. No.: 14/649,159

(22) PCT Filed: Dec. 3, 2013
(86) PCT No.: PCT/GB2013/053201

§ 371 Date: Jun. 2, 2015

(30) Foreign Application Priority Data
Dec. 3, 2012 (GB) 1221721.2

(51) Int. Cl. H04N 21/2385; H04N 21/2665; H04N 21/61

(52) U.S. Cl. CPC H04N 21/2385; H04N 21/6143; H04N 21/6112; H04N 21/6118; H04N 21/2665

(57) ABSTRACT

Apparatus and a system is provided to allow the distribution of received data to a number of data processing apparatus and to make selected portions of the data available to each of the data processing apparatus in response to a user selection. The network includes the use of first and further data processing components which can be provided as integrated circuits and which therefore do not require the use of conventional electromechanical switching apparatus.

The invention to which this application relates is apparatus which allows the distribution of data such as video and/or audio and, in particular, although not necessarily exclusively, to the distribution of audio and video data for use in the provision of television, internet, telephony and/or auxiliary services.

The distribution of data to allow the provision of any, or any combination, of the services indicated above is well known and increasing numbers of the population are provided with these services. As the demand increases, and the range of services which can be provided increases, so there is increasing pressure on the ability to effectively distribute the data.

The applicant, in previous patent applications has identified the ability to provide a distribution network which allows the reception of data for these services via any of satellite, cable or other transmission systems and to then convert the received data into an optical format, at least for a portion of the distribution network, in order to allow the more efficient and wider distribution of the data through the network to a number of premises, or parts of premises, and still allow the independent selection and control at each of these premises of all of the services. In one embodiment, the portion of the network which is optical fibre, extends from the receiving apparatus to the processing apparatus at each of the premises or parts of the premises or, alternatively, the optical fibre portion is provided to carry data which has been converted into an optical format to one or more of the said premises, and at which point the optical format data is reconverted back to a format to be output on coaxial cable connections to allow the same to be processed by conventional apparatus provided at the premises. This latter system is largely utilised as it allows the conventional and existing apparatus, typically referred to as broadcast data receivers or set top boxes, to be used at the premises and also allows conventional IF switching apparatus to be used with the reconverted format data at the premises. This therefore means that, at present, it is more common for larger capacity Gateway Termination Units (GTU'S) to be installed in the distribution network intermediate the data receiving location and the premises in order to allow multiple IF outputs to be passed to IF switching devices downstream and allow the distribution to premises from the same in the IF format, rather than providing the GTU at each of the premises in order to provide the IF outputs therefrom. However the conventional switching apparatus which is used can be extremely complex and expensive to install.

The applicant has also, in their co-pending application GB1211670.3, developed components which allow the cost of the distribution networks which utilise optical fibre to be reduced and thereby allow the increased utilisation and installation of distribution networks which utilise optical fibre.

The aim of the present invention is to provide an improved data distribution system in which there is a reduced need to utilise conventional mechanical and/or electrical switching apparatus.

In a first aspect of the invention there is provided apparatus for the distribution of data signals which are received by receiving apparatus within one or more predetermined frequency bands, to a plurality of receiving locations, said apparatus including at least one first data processing component which has an input to receive the data signals in the predetermined frequency band and pass the said data signals along at least two paths, each path leading to an output and from which outputs the said data signals are supplied to a plurality of further data processing components each connected via an input connected to an output of the at least one first data processing component, and wherein the said further data processing components have at least two outputs, each of said outputs selectably connected to a data processing apparatus for the generation of video and/or audio therefrom, said data processing apparatus including means to generate a signal and transmit the same to the further data processing component to which the same is connected to indicate a portion of the said received data signal which is to be processed at that time and the said portion of the said received data signal is retrieved and passed to the said data processing apparatus.

Typically the signal which is received from the data processing apparatus is representative of a user selection made via the data processing apparatus to select to watch and/or listen to a particular television or radio programme and the signal is indicative of the portion of the data which is required to be processed in order to allow the video and/or audio to be generated for that programme.

In one embodiment each of the outputs of the plurality of further components is attached to a separate data processing apparatus. Typically the selection signal received from the apparatus connected to each of the outputs is processed independently of the selection signals received from the other of the data processing apparatus such that at any given time a selected portion of the data signals which is transmitted through one of the outputs may be different to a selected portion of data transmitted through the other outputs of the further data processing components. This allows the appropriate portion of data to allow the generation of the video and/or audio for the selected programmes, which typically will be different for each data processing apparatus, to be retrieved and processed accordingly.

Typically the said first and further data processing components are provided as integrated circuits.

In one embodiment the first data processing component acts as a buffer driver for operation in the frequency range of 88 MHz to 5.45 Ghz and the further data processing components act as a dual channel IF band digital data destacker and the first and further components are operated in conjunction to allow the receipt, processing and selective positioning of at least one IF frequency band of the received data signals within the received frequency. The components also allow the separation of the received data signals into at least two distinct frequency bandwidths within said received frequency range and the independent processing of the same to generate at least two data outputs and thereby allow the selection of the portion of the data in response to the signal received from the data processing apparatus connected to the respective outputs.

Typically the first component operates as an amplifier with a 88 MHz to 5.45 GHz frequency range and a switchable gain of 2 or 17 dB.

In one embodiment the gain is used in relation to received data signals in the known satellite IF and/or terrestrial TV frequency bands.

Typically the further data processing components allow the transfer of the selected portion of the received IF frequency band to another IF frequency band to provide the required separation between the same for efficient processing.

In one embodiment the IF frequency band which is used is selected from a range of IF bands and is selected to suit the specific purpose to which the components are to be put. In one embodiment each of the further data processing components include at least two down convertors which can be set to select the IF band from the range of available IF bands.

In one embodiment the said further data processing components are used as part of a data distribution network to remove the need for relatively complex conventional switching apparatus to be used in order to connect the network to multiple data processing apparatus.

In one embodiment the said further data processing components are used to form the equivalent of a GTU with a 5*4 switch and in the current invention neither the GTU or switch are required to be used therefore representing considerable savings in installation time and cost.

In another embodiment the said further data processing components are used to form the equivalent to a GTU with a 5*8 switch by connecting a two of the further data processing components in cascade to another of the further data processing components via an output therefrom so as to provide eight outputs in the form of four sets of further data processing components, each having two outputs.

In one embodiment a plurality of said further data processing components are used, in combination, to allow a plurality of outputs to be provided and from each of which the same data signals are available to be accessed by data processing apparatus and which data processing apparatus may be located at a number of different locations such as different rooms in the same premises, different apartments in a block of apartments and/or different houses in a group of houses, all of which, in each case are connected to the common distribution network.

In one embodiment, two or more data signal feeds are connected to a set of the said data processing components.

In one embodiment there are provided two data signal feeds, a first having horizontal polarity and a second with vertical polarity connected to one or more of the first components. In one embodiment the vertical polarity data signal path from a first component is connected to a further data processing component at a first receiving location and a further data processing component at a second receiving location to allow the vertical polarity output data to be selectively processed and output by said further components at the first and second receiving locations respectively. The output of the horizontal polarity data from the first data processing component is connected to a further component at the first location and a further component at the second location to allow the horizontal polarity output data to be selectively processed and the outputs from the respective further components can be connected to data processing apparatus at the respective receiving locations.

In one embodiment only the further components are used in connection to receive data from a satellite diplexer which diplexes the horizontally and vertically polarised data which has been processed in a conventional manner upstream.

In one embodiment the first component is provided with a first feed path for data relating to a terrestrial audio and/or video service and further feed paths, each of which can be connected to a further component and typically each of the further components has at least two IF data signal outputs therefrom.

Typically each of the outputs of the further data processing components can be used to select data from any received IF band and/or in any received polarisation.

Typically the further component outputs are controlled via tone/volts or Diseqc signals received from the data processing apparatus in order to allow selection of the particular band or polarisation of data signal from which the required data portion is to be retrieved and to be used from each of the outputs, typically in response to a user selection to view and/or listen to a programme via apparatus connected thereto.

In one embodiment, the said further components can be provided in a cascaded manner to provide multiple outputs, each available to be connected to a data processing apparatus. Typically the cascading is achieved by connecting a further component to an amplifier/splitter output of another further component and so on with the interconnection of subsequent further components so as to build a system with the required outputs capacity.

In another embodiment, the said first and further component configurations are configured to act as switch sets for a multi wire fibre optic distribution system, with a first switch set connected to a first fibre optic data supply, a second switch set connected to a second fibre optic data supply, and so on with further fibre optic data supplies as required. Typically the outputs which are available from each of the further components in each switch set will be the same.

In one embodiment, the first and further components are used at a plurality of different premises, or parts of premises, to receive data which is received from a common LNB, with a first one of the first components used to process received data with a first polarity and a further one of the first components used to process received data with a second polarity, with a first output from each of said first components connected respectively to one or more further components at a first location and a second output from each of the first components connected respectively to one or more further components at a second location to provide the required multiple IF outputs therefrom.

In a further aspect of the invention there is provided a data distribution network for the distribution of data to a plurality of locations connected to the network to make the data available for selection and processing in response to user interaction with connected apparatus at said locations, said network including means to allow the supply of the data to each of the locations and wherein the said means are formed by at least one first component connected to at least one input to the network upstream of the same and via first and second outlets to respective further components, said further components providing a plurality of data outlets to allow the selective connection of data processing apparatus to each of the same and with which the user can interact to cause the selection by the data processing apparatus, independently of the other data processing apparatus, to receive a portion of the said data which is to be processed and which data is provided from the said outlet of the further component to which the data processing apparatus is connected.

Typically each of the outlets from the further components provide data which is common to each of the outlets and which is available for selection for processing, independently, via apparatus connected thereto.

In a further aspect of the invention there is provided apparatus for the distribution of data signals to a plurality of receiving locations, said apparatus including at least one input to receive the data signals carried in a required frequency band, said data signals passing along at least two paths to provide two outputs, each of which is connected to a data processing apparatus, each of said data processing apparatus provided with means to emit a signal representative of the selection of a portion of the data signal which is required to be received for processing to allow a user selected television and/or radio programme to be generated by the data processing apparatus and the said portion of data is retrieved and passed to the said data processing apparatus which emitted the signal.

It should be noted that although reference is made to the use of first and further data processing components, the same may be combined into an integral unit and provide the same features and inventive aspects as described herein and therefore reference to the first and further components encompasses the first and further components provided as separate interconnected items and/or integrated into one item.

Specific embodiments of the invention are now described with reference to the accompanying diagrams in which;

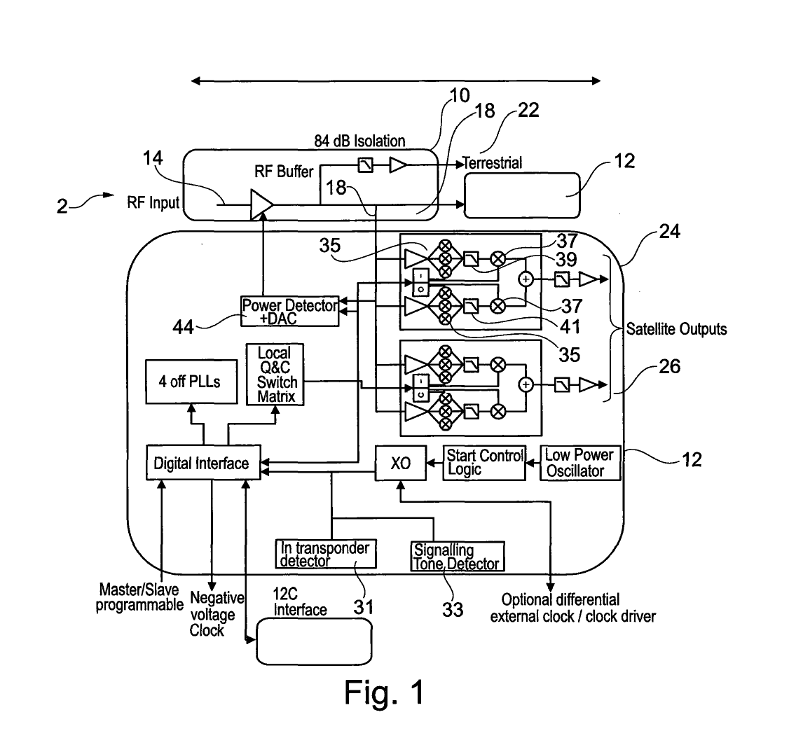

FIG. 1 illustrates the first and further data processing components connected in accordance with one embodiment of the invention;

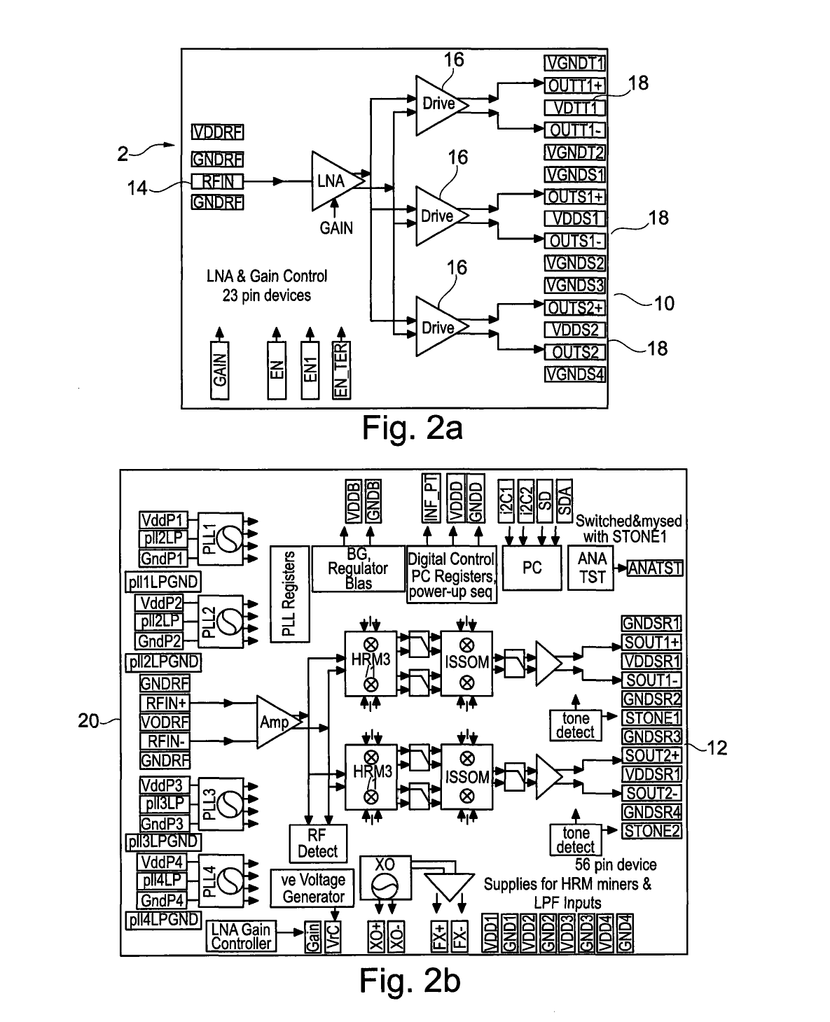

FIGS. 2a and b illustrate views of the first and further components in accordance with one embodiment of the invention;

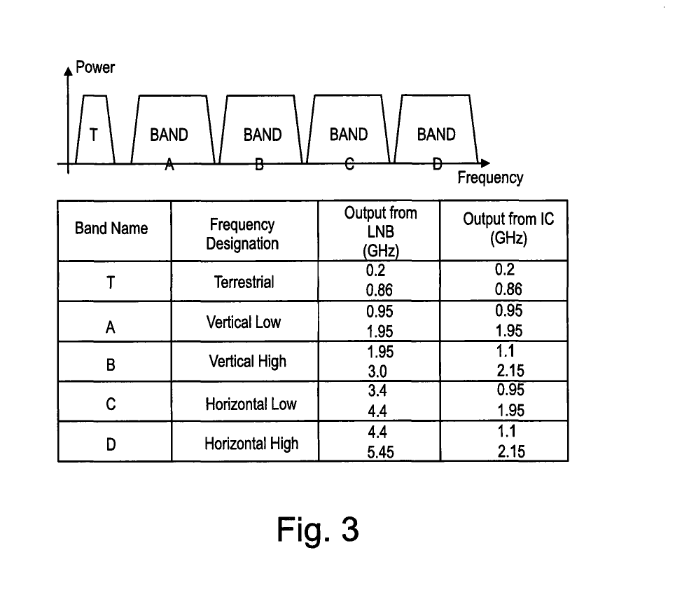

FIG. 3 illustrates the range of IF bands which can be selected using the further component of FIG. 2b in one embodiment;

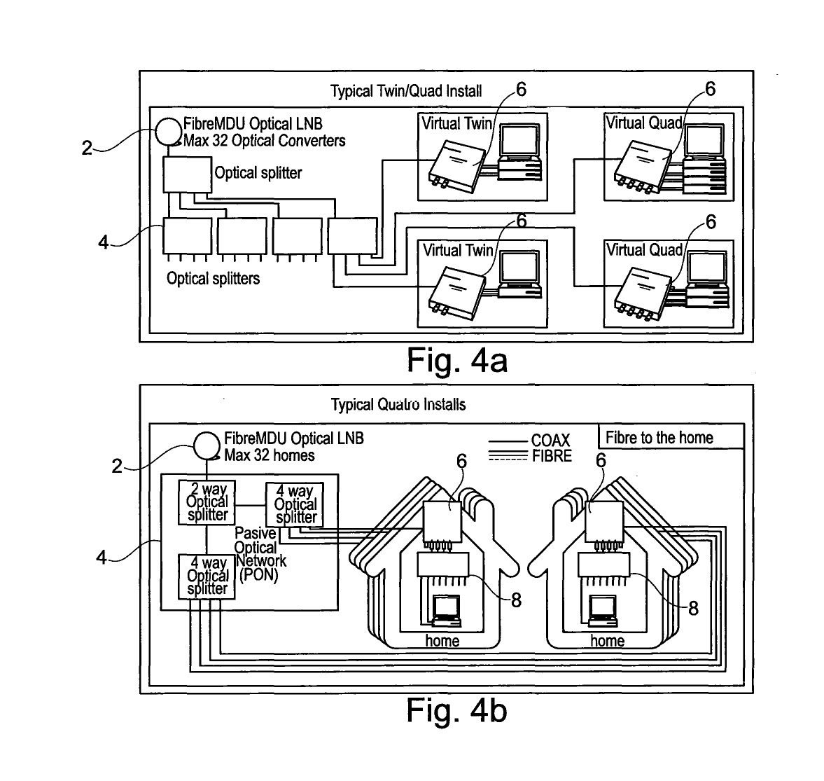

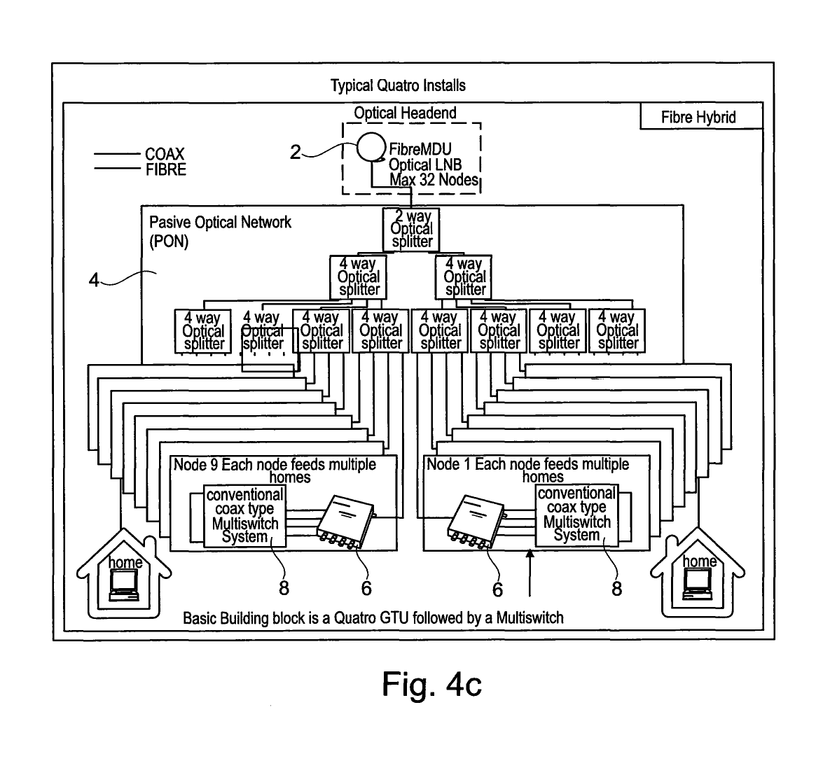

FIGS. 4a-c illustrate conventional data distribution networks which utilise optical fibre;

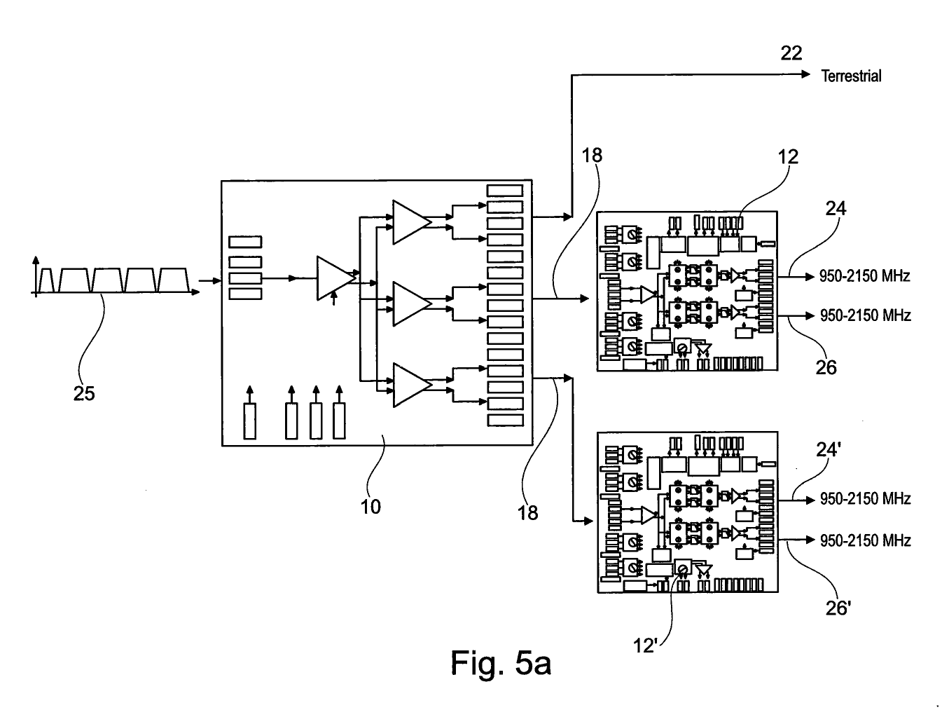

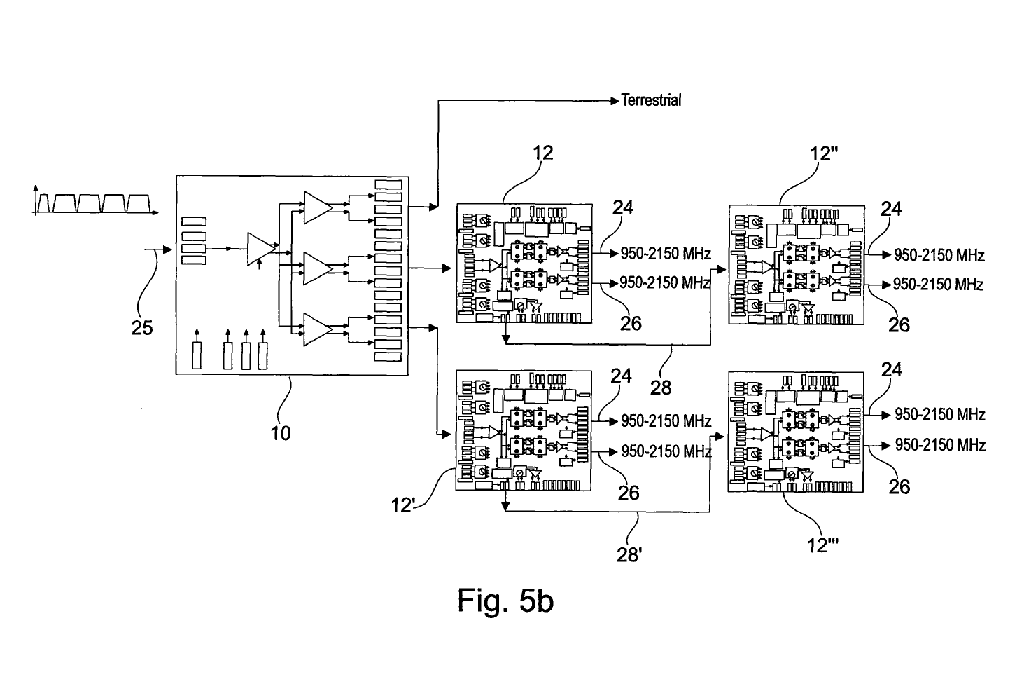

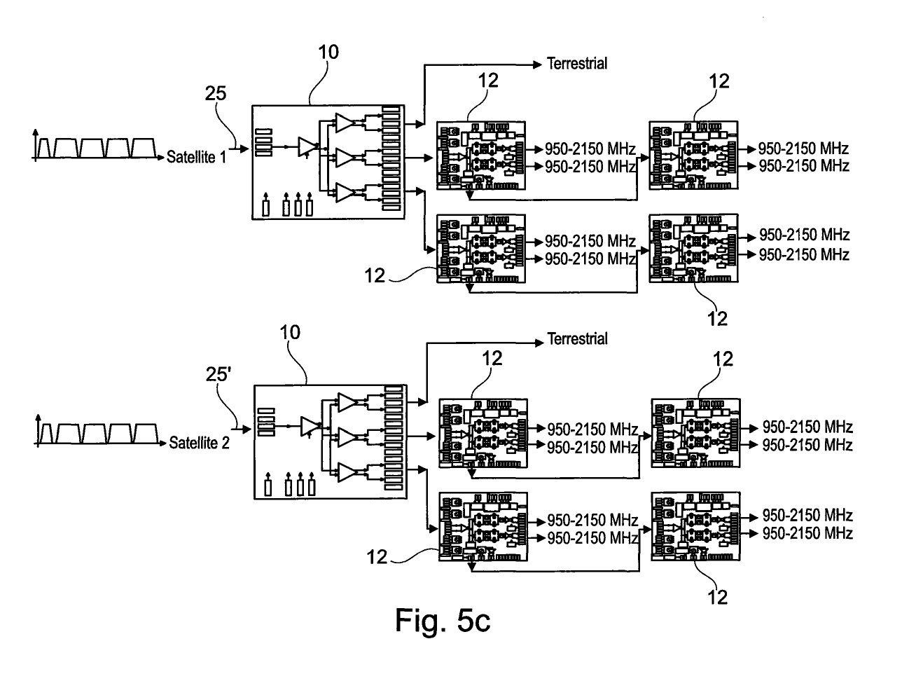

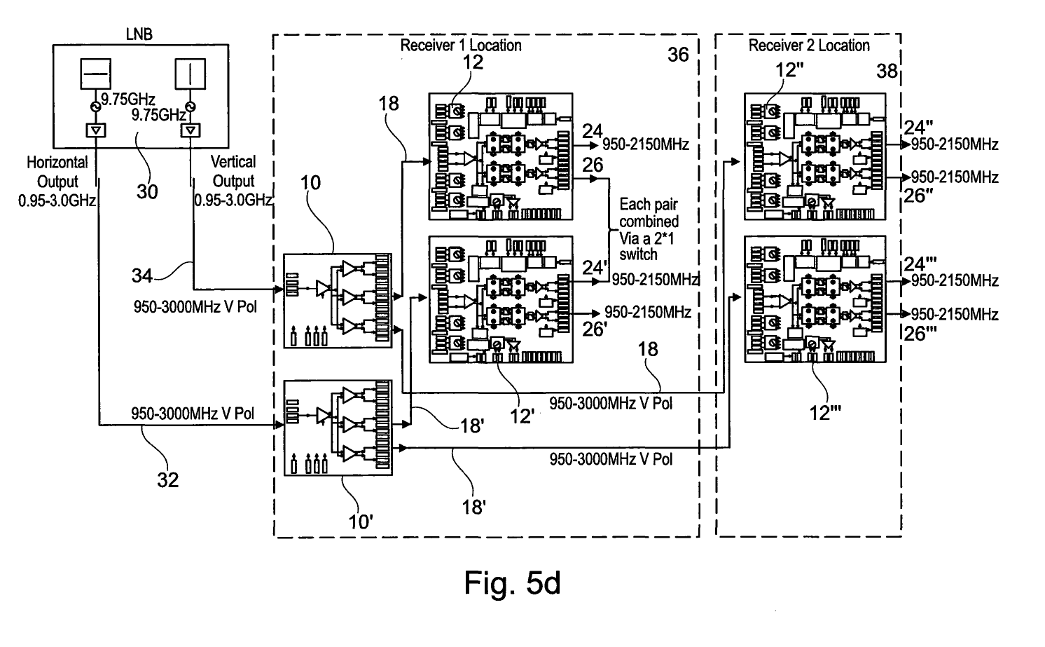

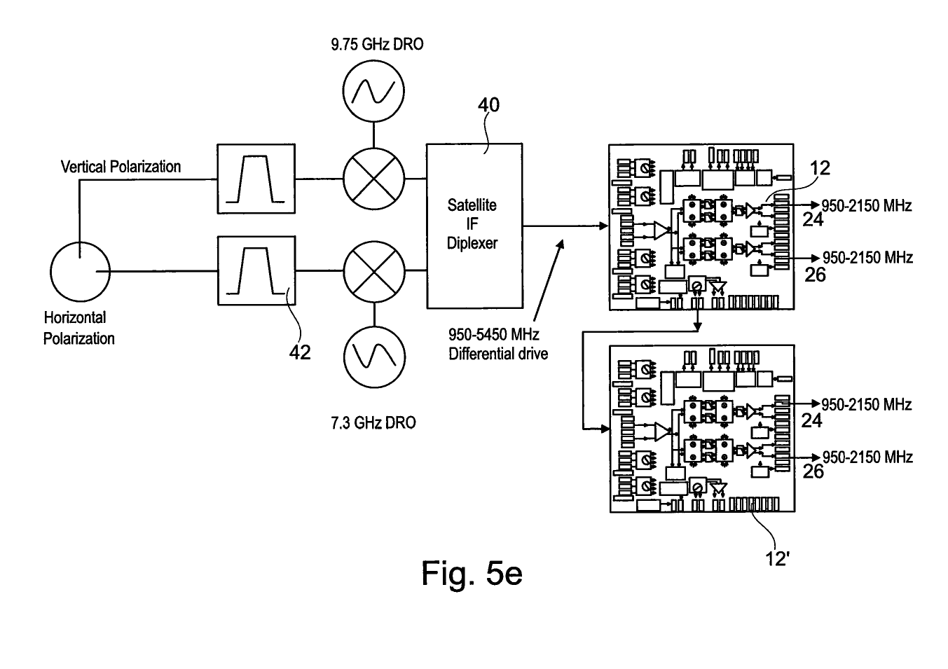

FIGS. 5a-e illustrate embodiments of use of the first and further components of FIGS. 1-3.

Referring firstly to FIGS. 4a-c there are illustrated known data distribution systems. In each case the data is received at a location 2 via satellite receiving apparatus. The data signals are received in radio frequency (RF) format and is then converted into an optical format and passed to a plurality of optical data splitters 4, each of which are connected to a distribution unit 6 which is provided at a specific domestic premises, as shown in FIGS. 4a and b, or can be provided in a network with multiple premises connected to each of the units 6 as shown in FIG. 4c. The data output from the Unit 6 is reconverted into the radio frequency format and is passed to switching means 8 as shown in FIGS. 4b and c which have a number of outputs and allow the connection of coaxial cables thereto. This, in turn, leads to the data processing apparatus at different parts of a premises as shown in FIG. 4b or at different premises as shown in FIG. 4c. It will be appreciated that the requirements to provide the multi switch apparatus at each premises is expensive and is limited in terms of the number of outputs which can be provided from the switch apparatus due to the mechanical constraints of the same.

Referring now to FIGS. 1 and 2 there are shown a distribution network in accordance with the invention. The apparatus includes a first data processing component 10 and further data processing components 12, in accordance with one embodiment of the invention.

The first data processing component 10 includes at least one input 14 to receive a data feed from the receiving location 2 and a plurality of drive or feed amplification paths 16, fed from a Low Noise Amplifier (LNA) and each path 16 leads to a respective output 18. As many outputs 18 as required can be provided from the first data processing component 10. In the arrangement shown in FIG. 1 there is provided a first component 10 and two further components 12, one of which 12′ is shown in an expanded format for illustration purposes.

The data signals which are received at the input 14 are provided within one or more predetermined frequency bands and the respective frequency bands which are received are stacked as part of the processing of the data and are all available from each of the outlets 18 of the first data processing component 10 so that all of the received data signals which are carried into the input are available from each of the outlets 18. Each of the outlets 18 from the first data processing component 10 can be connected to one of the further components 12.

In this embodiment the data signals which are received are split into different IF bands with a frequency range as shown in FIG. 3 with a terrestrial data signal band T and data signals received via satellite antenna provided within frequency bands A,B,C,D. The frequency bands A,B,C,D are separated by a predetermined degree of separation frequency and that is maintained between the bands A,B,C or D in order to minimise interference of the data signals.

The combination of the first and further data processing components 10,12 allow a terrestrial output 22 to be provided from the first data processing component 10, and first and second data signal outputs 24, 26 to be provided from each of the further data processing components 12. In accordance with the invention as herein described the first and further data processing components 10,12 are used in selected combinations and differing configurations to act as switching means to provide the required data signals to the data processing apparatus at the specified locations and can be used in place of the conventional switching means shown in FIGS. 4a-c. This allows the same data signals to be available for selection from each of a plurality of outputs 24, 26, with typically, each of the further components having two available outputs 24,26 and as many of the further data processing components 12 are provided as required to suit specific distribution requirements.

The components are typically provided as integrated circuits and may be provided separately and connected or may be integrated on to one IC.

In each of the said further data processing components 12 in one embodiment there are provided two data processing paths leading from the connection to the outlet 18 from the first data processing component to an outlet 24,26. Each of the processing paths utilise the same components in order to allow the data to be processed and made available at the outlets 24,26 in the same form. The particular portion of data which is selected to be output from the respective outlets 24,26 is dependent upon the signal received from the data processing apparatus, such as a broadcast data receiver (not shown) which is connected to the outlet. The components of each of the processing paths can be selected to suit the specific requirements and may in one embodiment bas described in the applicants copending application PCT/GB2013/051751 with each path being, if required, a combined transmitter and receiver, for filtering and transmitting the wanted frequency band to the broadcast data receivers connected to the outputs 24,26. A detector 33 is provided for each output for detecting the control signal from the broadcast data receiver connected to a particular output 24,26 which determines which portion of the received frequency bands is to be the wanted frequency band in response to a user selection made via the broadcast data receiver. The said detector is connected to the transponder detector 31.

In each path first mixing means 35 are provided to process the data signals of the said wanted frequency band from the input 18 and in-phase I and quadrative data paths Q can typically be provided to create a predefined representation of the wanted frequency band and which feed the first mixing means 35 and the second mixing means 37 respectively. The data from the first mixing means is passed along the respective data feeds to the second mixing means 37 via respective filters 39,41 to convert the wanted frequency band to the required frequency band output for receipt by at least one broadcast data receiver and/or one or more tuners connected to an output 24, 26 of the further data processing component.

Typically the further data processing component also includes a power detector 44, and the ability to detect the presence of the transponders in each frequency band and hence the gaps between the same.

Examples of the utilisation of the invention are now described.

In FIG. 5a there is shown a first configuration in which there is provided an input feed 25 from a GTU as part of a data distribution network. The outputs from the first component 10 include a terrestrial service output 22, a first output 18 which is connected to a further component 12 and a second output 18′ which is connected to a further component 12′. Each of the components 12,12′ then has outputs 24,26, 24′, 26′ respectively and each of those outputs provides feed of the same data and which is the same so that each of the items of data processing apparatus connected to the outputs 24,26,24′,26′ has the same data available to it. The selection of the portion of that data which is supplied from each of the outputs can then be controlled independently via the data processing apparatus connected thereto. The control is achieved by a signal which is sent from the data processing apparatus to the output to which it is connected. The signal is indicative of the portion of the available data which that apparatus requires at that time to provide a selected service such as a television programme to the user. The identification of the required portion of data can be undertaken in a conventional manner by the apparatus in response to user interaction therewith, typically via a remote control device, and the signal which is then sent from the data processing apparatus is detected by the further component 12,12′ providing the appropriate output and the said portion of data identified and sent via the appropriate output from the said further component 12,12′ to the data processing apparatus from which the signal was sent. The arrangement shown in FIG. 5a is equivalent to a GTU with a 5*4 switch and neither the GTU or switch are now required to be used therefore representing considerable savings in installation time and cost.

FIG. 5b illustrates a further configuration which is equivalent to a GTU with a 5*8 switch and this is achieved by connecting further components 12″ and 12′″ to the further components 12 and 12′ respectively via respective outputs 28, 28′ so as to provide eight outputs in the form of the four sets of outputs 24,26 from the respective further components, 12, 12′,12″, 12′″. FIG. 5c illustrates an arrangement where there are provided two input feeds 25, 25′ and each is connected to a set similar to that shown in FIG. 5b and which includes first and further components 10,12 as shown. It should be appreciated that the particular configuration and connection of the further components 12 can be selected to suit specific purposes, such as the example shown in the configuration of FIG. 5b.

FIG. 5d illustrates a further arrangement in which there is provided an Low Noise Block 30 provided as part of the satellite receiving apparatus 2 and which has horizontal and vertical polarity data signal outputs 32, 34 respectively and which are respectively connected to first components 10, 10′. The outputs 18 from component 10 are connected to a further component 12 at a first receiving location 36 and a second component 12″ at a second receiving location 38 to allow the vertical polarity output to be processed and output by further components at the first and second receiving locations 36,38 respectively. The outputs 18′ from component 10′ are connected to further component 12′, 12′″ at the first and second locations 36,38 respectively to allow the horizontal polarity output data to be processed and the outputs, 24,26, 24′26′, 24″,26″, 24″, 26′″ from the respective components 12, 12′, 12″, 12′″ can be connected to data processing apparatus at the respective locations so that all of the vertical and horizontal polarity data signals can be available to each of the data processing apparatus at the respective locations.

FIG. 5e illustrates a yet further embodiment of the invention in which only the second components 12, 12′ are used in connection to receive data from a satellite diplexer 40 which diplexes the horizontal and vertically polarised data which has been processed in a conventional manner upstream 42. In this case each of the further components 12, 12′ again provides outputs 24,26 so that in this configuration four data outputs are available and from each of which the same data is available.

There is therefore provided in accordance with the invention multiple applications of the components as described and which extends the potential market for the said components.

1. Apparatus for the distribution of data signals which are received by receiving apparatus within one or more predetermined frequency bands, to a plurality of receiving locations, said apparatus including at least one first data processing component which has an input to receive the data signals in the predetermined frequency band and pass the said data signals along at least two paths, each path leading to an output and from which outputs the said data signals are supplied to a plurality of further data processing components each connected via an input connected to an output of the at least one first data processing component, and wherein the said further data processing components have at least two outputs, each of said outputs selectably connected to a data processing apparatus for the generation of video and/or audio therefrom, wherein said data processing apparatus including means to generate a signal and transmit the same to the further data processing component to which the same is connected to indicate a portion of the said received data signal which is to be processed at that time and the said portion of the said received data signal is retrieved and passed to the said data processing apparatus.

2. Apparatus according to claim 1 wherein the signal which is received from the data processing apparatus is representative of a user selection made via the apparatus to select to watch and/or listen to a particular television or radio programme and the signal is indicative of the portion of the data signals which is required to be sent to and processed by the data processing apparatus in order to allow the video and/or audio to be generated for that programme.

3. (canceled)

4. Apparatus according to claim 1 wherein the selection signal received from the apparatus connected to each of the outputs is processed separately to a selection signal from the other of the data processing apparatus such that at any given time a selected portion of the data signals which is transmitted through one of the outputs may be different to the selected portion of data transmitted through the other of the outputs.

5. Apparatus according to claim 1 wherein the said first and further components are integrated circuits.

6. Apparatus according to claim 1 wherein the first component acts as a buffer driver and amplifier for operation in the range of 88 MHz to 5.45 Ghz and the further component acts as a dual channel IF band destacker.

7. Apparatus according to claim 6 wherein the first component has a switchable gain between 2 and 17 dB.

8. Apparatus according to claim 1 wherein the first and further data processing components are operated in conjunction to allow the receipt and processing and selective positioning of at least one IF band of the received data within the said range and to allow the separation of the received data into at least two distinct frequency bandwidths within said range and the independent processing of the same to generate at least two data outputs.

9. Apparatus according to claim 7 wherein the gain is used with respect to satellite IF and/or terrestrial TV data signal frequency bands.

10. Apparatus according to claim 1 wherein the further component allows the transfer of the selected portion of the received IF band to another IF frequency band selected from a range of IF bands to provide the required separation between the same for efficient processing.

11. (canceled)

12. Apparatus according to claim 1 wherein the components include at least two down convertors which can be set to select the IF band from the range of available IF bands.

13. (canceled)

14. (canceled)

15. Apparatus according to claim 1 wherein a plurality of said further data processing components are used, in combination, to allow a plurality of outputs to be provided and from each of which the same IF data range is available to be accessed by data processing apparatus connected thereto.

16. (canceled)

17. Apparatus according to claim 1 wherein two or more data signal feeds are connected to a set of the data processing components, a first having horizontal polarity and a second with vertical polarity.

18. (canceled)

19. Apparatus according to claim 17 wherein the vertical polarity data signal path from a first component is connected to a further component at a first receiving location and a further component at a second receiving location to allow the vertical polarity output data to be selectively processed and output by said further components at the first and second receiving locations respectively.

20. Apparatus according to claim 19 wherein the output from the first component of the horizontal polarity data signal is connected to a further component at the first location and a further component at the second location to allow the horizontal polarity output data to be selectively processed and the outputs from the respective further components.

21. Apparatus according claim 1 wherein only the further components are used in connection to receive data from a satellite diplexer which diplexes the horizontally and vertically polarised data which has been processed in a conventional manner upstream.

22. Apparatus according to claim 1 wherein the first component is provided with a first feed path for data relating to a terrestrial audio and/or video service and further feed paths, each of which can be connected to a further component and typically each of the further components has at least two IF outputs therefrom.

23. Apparatus according to claim 1 wherein the further component outputs are controlled via tone/volts or Diseqc signals in order to allow selection of the particular band or polarisation of data signal from which the required data portion is to be retrieved and to be used from each of the outputs, typically in response to a user selection to view and/or listen to a programme via apparatus connected thereto.

24. Apparatus according to claim 1 wherein the said further components are provided in a cascaded manner to provide multiple outputs, each available to be connected to a data processing apparatus.

25. Apparatus according to claim 24 wherein the cascading is achieved by connecting a further component to an amplifier/splitter output of another further component and so on with the interconnection of subsequent further components so as to build a system with the required output capacity.

26. Apparatus according to claim 24 wherein the said first and further component configurations are configured to act as switch sets for a multi wire fibre optic distribution system, with a first switch set connected to a first fibre optic data supply, a second switch set connected to a second fibre optic data supply, and so on with further fibre optic data supplies as required.

27. Apparatus according to claim 1 wherein the first and further components are used at a plurality of different premises, or parts of premises, to receive data which is received from a common LNB, with a first one of the first components used to process received data with a first polarity and a further one of the first components used to process received data with a second polarity, with a first output from each of said first components connected respectively to one or more further components at a first location and a second output from each of the first components connected respectively to one or more further components at a second location to provide the required multiple IF outputs therefrom.

28. A data distribution network for the distribution of data to a plurality of locations connected to the network to make the data available for selection and processing in response to user interaction with connected apparatus at said locations, said network including means to allow the supply of the data to each of the locations and wherein the said means are formed by at least one first component connected to at least one input to the network upstream of the same and via first and second outlets to respective further components, said further components providing a plurality of data outlets to allow the selective connection of data processing apparatus to each of the same and with which the user can interact to cause the selection by the data processing apparatus, each of the outlets from the further components provide data which is common to each of the outlets and which is available for selection for processing, by each of the data processing apparatus. independently of the other data processing apparatus, to receive a portion of the said data which is to be processed and which data is provided from the said outlet of the further component to which the data processing apparatus is connected.

29. (canceled)

30. Apparatus for the distribution of data signals to a plurality of receiving locations, said apparatus including at least one input to receive the data signals carried in a required frequency band, said data signals passing along at least two paths to provide two outputs, each of which is connected to a data processing apparatus, each of said data processing apparatus provided with means to emit a signal representative of the selection of a portion of the data signal which is required to be received for processing to allow a user selected television and/or radio programme to be generated by the data processing apparatus and the said portion of data is retrieved and passed to the said data processing apparatus which emitted the signal.
